(19) United States
(12) Patent Application Publication
(10) Pub. No.: US 2020/0082086 A1
(43) Pub. Date: Mar. 12, 2020

(54) SOFTWARE IMAGE DOWNLOAD SECURITY

(71) Applicant: Hewlett Packard Enterprise Development LP, Houston, TX (US)

(72) Inventors: Yashavantha NAGARAJU, Bangalore (IN); Nitin Singla, Banglore (IN); Norbert H. Vicente, Orangevale, CA (US); Praveen Ramesh Ganjam, Bangalore (IN)

(21) Appl. No.: 15/883,038

(22) Filed: Jan. 29, 2018

(51) Int. Cl. G06F 21/57; H04L 9/32; G06F 21/64

(52) U.S. Cl. CPC G06F 21/57; G06F 2221/033; G06F 21/64; H04L 9/3239

(57) ABSTRACT

A software image download security method may include storing an authentic cryptographic hash for an authentic software image at an authentication server, receiving, at the authentication server from a client network device, a candidate cryptographic hash for a candidate software image for which a download request has been received by the client network device, comparing, at the authentication server, the candidate cryptographic hash to the authentic cryptographic hash, and transmitting a result of the comparing to the client network device, wherein the client network device is to not download the candidate software image in response to the candidate cryptographic hash not matching the authentic cryptographic hash.

### BACKGROUND

Many client network devices operate in accordance with executable files received as software images over a wide area network, such as the Internet. The client network devices may comprise network devices, such as routers and switches, computing devices or various cloud connected appliances such as TVs and the like. The client network devices may download the executable files in response to receiving download requests. For example, a client network device may receive a request that the client network device download an upgrade or patch to an existing executable file. Once downloaded, the authenticity of the software image/executable file is sometimes verified using various authentication protocols facilitated by signatures contained in the downloaded file.

### BRIEF DESCRIPTION OF THE DRAWINGS

FIG. 1 is a schematic diagram illustrating portions of an example network system for carrying out an example software image download security method.

FIG. 2 is a schematic diagram illustrating portions of the network system of FIG. 1 refusing download of a software image pursuant to the example software image download security method.

FIG. 3 is a flow diagram of an example software image download security method from a perspective of the software image download requester.

FIG. 4 is a flow diagram of an example software image download security method from a perspective of a client network device.

FIG. 5 is a flow diagram of an example software image download security method from a perspective of an authentication server.

FIG. 6 is a flow diagram of an example software image download security network method.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example software image download security methods, non-transitory computer readable medium instructions and network systems that facilitate the identification of corrupt or inauthentic software images prior to their download. Because the methods, instruction and systems identify such corrupt or inauthentic software images/executable files even prior to their download, there is a reduced likelihood of the electronic device experiencing a virus, Trojan horse, malware or other system corruption. The disclosed methods, instructions and systems may provide enhanced way of providing security to those users who manage their devices via network management stations (NMS) without substantially impacting accessibility or usability of such network management stations.

The disclosed software image download security methods, non-transitory computer-readable medium instructions and network systems involve the creation of a cryptographic hash based upon the executable file/software image for which a download request is being made. For purposes of this disclosure, the term “cryptographic hash” refers to a hash generated based upon the contents of the file. Examples of such a cryptographic hash include, but not limited to, MD5, SHA1, and SHA256.

In such implementations, the computing device receiving the download request, the client network device, utilizes the received cryptographic hash to verify the authenticity of the file and/or the image download requester. For purposes of this disclosure, a “client network device” is a computing device connected to a wide area network, such as Internet, that receives a software image download request from the “cloud”, the wide area network. A client network device may comprise any networking element, such as a switch or router, a computing device, such as a laptop computer, desktop computer, smart phone and the like or any other device or appliance which may receive a software image download request from the cloud or wide area network, such as a smart TV or other smart appliance.

In such methods, instructions and systems, the generated cryptographic hash of the file to be downloaded is stored at an authentication server. In one implementation, the file to be downloaded is transmitted to the authentication server, wherein the authentication server generates and stores the cryptographic hash. In another implementation, the cryptographic hash is created remote from the authentication server, such as by the image download requester or by a source of the file to be downloaded, wherein the cryptographic hash is transmitted to the authentication server for storage or is transmitted to another storage site accessible by the authentication server.

The entity requesting downloading of the file by the client network device, the “image download requester”, transmits the cryptographic hash across a wide area network to the client network device along with the download request. The cryptographic hash sent to the client network device along with the download request is the same as the cryptographic hash stored at the authentication server or accessible by the authentication server. The cryptographic hash is used to verify the authenticity of the download request prior to downloading the software image/executable file.

Upon receiving an image download request from the image download requester, the client network device may identify the cryptographic hash in the download request. The client network device and then forward the cryptographic hash as part of the communication to the authentication server, requesting verification that the cryptographic hash (and the received download request) are authentic. This occurs prior to downloading of the file pursuant to the download request.

The authentication server utilized the received “candidate” cryptographic hash to verify the authenticity of the down a request made to the client network device. In other words, the authentication server may determine whether the download request, and the file to be downloaded pursuant to the download request are authentic or are from a “bad actor”, wherein the file to be downloaded may contain a virus, Trojan horse form of corruption. In one implementation, the authentication server compares values of the candidate cryptographic hash against those cryptographic hash is stored in a cryptographic hash database or record that are associated with authentic software images/executable files. The result of the comparison is communicated back to the client network device.

In response to receiving a communication from the authentication server indicating that the candidate cryptographic hash included with the download request is indeed authentic, the candidate cryptographic hash matches a cryptographic hash stored or obtained by the authentication server, the client network device may proceed with other security protocols or may carry out the software image download per the request. Alternatively, in response to the authentication server indicating that the candidate cryptographic hash is inauthentic or may be authentic, the candidate cryptographic hash either not matching any authentic cryptographic hashes stored are accessible by the authentication server or not found by the authentication server, the client network device may decline downloading of the file or disregard the download request. In some implementations, the client network device may carry out other actions in response to identifying the download request is coming from and inauthentic requester or source.

Disclosed herein is a software image download security method that may include storing an authentic cryptographic hash for an authentic software image at an authentication server, receiving, at the authentication server from a client network device, a candidate cryptographic hash for a candidate software image for which a download request has been received by the client network device, comparing, at the authentication server, the candidate cryptographic hash to the authentic cryptographic hash, and transmitting a result of the comparing to the client network device, wherein the client network device is to not download the candidate software image in response to the candidate cryptographic hash not matching the authentic cryptographic hash.

The method may further include storing a second authentic cryptographic hash for a second authentic software image at the authentication server, receiving, at the authentication server from a second client network device, a second candidate cryptographic hash for a candidate software image for which a download request has been received by the second client network device, comparing, at the authentication server, the second candidate cryptographic hash to the second authentic cryptographic hash and transmitting a result of the comparing to the second client network device, wherein the second client network device is to not download the second candidate software image in response to the second candidate cryptographic hash not matching the second authentic cryptographic hash.

Disclosed herein is a software image download security method that may include receiving, at a client network device, a download request that the client network device download a candidate software image, the request comprising a candidate cryptographic hash, transmitting, from the client network device, an authentication request to an authentication server, the authentication request comprising the candidate cryptographic hash, receiving an indication from the authentication server that the candidate cryptographic hash does not match in authentic cryptographic hash-based upon an authentic optical image and stored at the authentication server and not downloading the candidate software image in response to the indication from the authentication server.

The method may further include receiving, at the client network device, a second download request that the client network device download a second candidate software image, the request comprising a second candidate cryptographic hash, transmitting, from the client network device, a second authentication request to the authentication server, the second authentication request comprising the second candidate cryptographic hash, receiving a second indication from the authentication server that the candidate cryptographic hash matches a second authentic cryptographic hash that is based upon a second authentic optical image and that is stored at the authentication server; and downloading the second candidate software image in response to the second indication from the authentication server.

Disclosed herein is an example non-transitory computer readable medium which contains software image download security instructions. The instructions may direct a processing unit to transmit a download request to a client network device that the client network device download a software image, generate an authentic cryptographic hash of the software image, transmit the authentic cryptographic hash of the software image to the client network device; and transmit the authentic cryptographic hash of the software image to an authentication server that is to receive an authentication request that is from the client network device and that includes the authentic cryptographic hash.

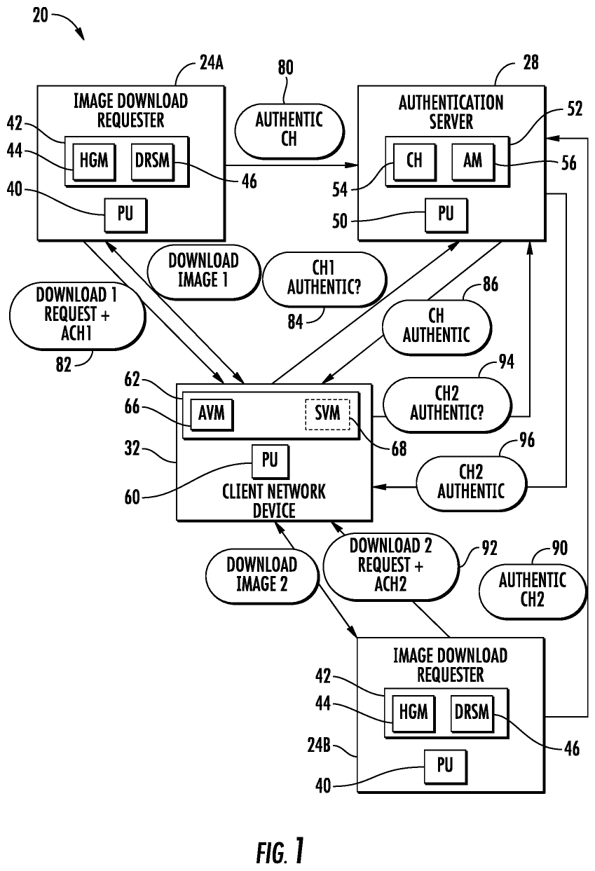

FIG. 1 is a schematic diagram illustrating portions of an example network system 20. FIG. 1 illustrates a system where a single authentication server may serve multiple image download requesters, storing or accessing cryptographic hash is based upon files that the image download requesters are requesting download by a client network device. Although FIG. 1 illustrates system 20 having a single client network device, a single authentication server and to image download requesters, it should be appreciated that system 20 may comprise any of a number of client network devices, authentication servers and image download requesters.

In the example illustrated, network system 20 comprises image download requesters 24A, 24B (collectively referred to as image download requesters 24), authentication server 28 and client network device 32. Image download requesters 24 are similar to one another and are each serviced by authentication server 24. Image download requesters 24 may comprise computing devices connected to a wide area network that transmit software image download request to client network device 32. Image download requesters 24 each comprise a processing unit 40 and memory 42.

Processing unit 40 carries out instructions provided in memory 42. For purposes of this disclosure, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random access memory (RAM) for execution by the processing unit 40 from a read only memory (ROM), a mass storage device, some other persistent storage or some other non-transitory computer-readable medium forming memory 42. In other embodiments, hard wired circuitry may be used in place of or in combination with software instructions to implement the functions described. For example, processing unit 40 and memory 42 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 42 comprises a non-transitory computer-readable medium which is readable are executable by processing unit 40. Memory 42 stores or comprises a hash generation module 44 and a download request security module 46. Hash generation module 44 comprises software or code/instructions contained in memory 42 that direct processing unit 40 (computer hardware) to generate a cryptographic hash based upon contents of a software image are executable file that is to be downloaded and executed by client network device 32 pursuant to a download request. Examples of such a cryptographic hashes include, but not limited to, MD5, SHA1, and SHA256 hashes or checksums.

Download request security module 46 comprises software or code/instructions contained in memory 42 that direct processing unit 40 to carry out security functions pertaining to requesting client network device 32 to download a software image/executable file. Download request security module 46 directs processing 40 to transmit the authentic cryptographic hash generated pursuant to hash generation module 44 for a particular file to be associated with a download request to client network device 32. Download request security module 46 further directs processing unit 40 to transmit the generated authentic cryptographic hash to client network device 32 along with the request being made to client network device 32 for downloading the software image upon which the cryptographic hash is based.

Authentication server 28 comprises a computing device that stores or accesses the authentic cryptographic hash received from the various image downloading requesters 24. Authentication server 28 further response to authentication requests from various client network devices, such as client network device 32. Although the authentication verification functions are illustrated as being carried out by a single authentication server 28, it should be appreciated that authentication server 28 may comprise multiple authentication servers that share such responsibilities.

As shown by 1, authentication server 28 comprises processing unit 50 and memory 52. Processing unit 40 carries out instructions provided in memory 52.

Memory 52 comprises a non-transitory computer-readable medium which is readable are executable by processing unit 50. Memory 52 stores or comprises cryptographic hash storage 54 and authentication module 56. Cryptographic hash storage 54 comprises that portion of memory 52 that stores values for the various cryptographic hashes (CH) received from various image download requesters 24. In one implementation, the cryptographic hashes are stored in a table. In another implementation, the cryptographic hash may be stored in a table and associated with file identifiers, identifying the file on which the cryptographic hash was based. In other implementations, cryptographic hash storage 54 may be separate from authentication server 28 or remote from authentication server 28, wherein authentication server 28 accesses cryptographic hash storage 54 across a local area network or across a wide area network. In some implementations, authentication server 28, rather than receiving an authentic cryptographic hash from each image download request or, may receive files and may itself generate a cryptographic hash which is stored for subsequent authentication procedures.

Authentication module 56 comprises software or code/instructions contained in memory 52 that direct processing unit 50 to carry out security functions pertaining to verifying the authenticity of a candidate cryptographic hash and responding to a client network device regarding the authenticity. Upon authentication server 28 receiving an authentication request from client network device 32, across a wide area network, authentication module 52 direct processing unit 50 to extract or identify the candidate cryptographic hash from the authentication request received from client network device 32. Authentication module 56 to further direct processing unit 50 to compare the candidate cryptographic hash received as part of the authentication request from client network device 32 to the values for the authentic cryptographic hash is stored in cryptographic hash storage 54. In one implementation, authentication module 50 directs processing unit 50 to compare both an extracted file identifier, a name or label of the file which a download request is being made and the received candidate cryptographic hash to each stored file identifier and its associated authentic cryptographic hash. Authentication module 56 directs processing unit 50 to communicate the results of the comparison to client network device 32, indicating whether the image download request is authentic, whether the file requested to be downloaded is authentic and/or whether the image download request or is authentic or to be trusted.

Client network device 32 comprises a computing device connected to a wide area network, such as Internet, that receives a software image download request from the “cloud”, the wide area network. Client network device 32 may comprise any networking element, such as a switch or router, a computing device, such as a laptop computer, desktop computer, smart phone and the like or any other device or “smart” appliance which may receive a software image download request from the cloud or wide area network, such as a smart TV or other smart appliance. Client network device 32 communicate with each of image download requesters 24 and authentication server 28 across a wide area network, the Internet or the “cloud”. Client network device 32 comprises processing unit 60 and memory 62. Processing unit 60 carries out instructions contained in memory 62.

Memory 62 comprises a non-transitory computer-readable medium that includes instructions for processing unit 60. Memory 62 comprises authentication verification module 66. Authentication verification module 66 comprises software or code/instructions contained in memory 62 that direct processing unit 60 to carry out security functions pertaining to verifying the authenticity of a download request received from one of image download requesters 24. Upon client network device 32 receiving a download request along with a candidate cryptographic hash, authentication verification module 66 directs processing unit 60 to transmit the received candidate cryptographic hash along with an authenticity request to authentication server 28. This occurs prior to any downloading of the file pursuant to the received download request. Upon receiving a response indicating the authenticity or lack thereof for the download request, authentication verification module 66 directs processing unit 60 to either carry out the download of the file pursuant to the received download request or refuse or deny the download request, not downloading any file pursuant to the request. For example, upon receiving an indication from authentication server 28 that the candidate cryptographic hash does match a stored cryptographic hash value in cryptographic hash storage 54, authentication verification module 66 may direct processing unit 62 carry out additional security protocols or may proceed with downloading the file pursuant to the download request. Alternatively, upon receiving an indication from authentication server 28 that the candidate cryptographic hash is inauthentic or does not match any cryptographic hash value stored in cryptographic hash storage 54, authentication verification module 66 may direct processing unit 60 to not acknowledge the download request, refused to download the file to the request or take other actions other than downloading the file pursuant to the request.

As indicated in broken lines, in one implementation, memory 62 may additionally comprise signature verification module 68. Signature verification module 68 comprises software or code/instructions that direct processing unit 60 to carry out additional security protocols following the downloading of the file pursuant to the download request. In one implementation, signature verification module 68 directs processing unit 60 to verify a digital signature embedded in the downloaded file. In yet other implementations, signature verification module 68 may be omitted or other security protocol modules may be stored in memory 62 for directing processing unit 60.

FIG. 1 schematically illustrates two example file downloading transactions with respect to client network device 32, where both of such transactions are trusted transactions or authentic transactions. In one example file downloading transaction between image download requester 24A and client network device 32, image download requester 24A generates an authentic cryptographic hash 80 which is transmitted to authentication server 28 for storage in cryptographic hash storage 54. Image download requester 24A further transmits a software image download request (DOWNLOAD 1 REQUEST) and an authentic graphic hash (ACH1) 82 to client network device 32 across a wide area network. In one implementation, the transmission of the download request and the authentic cryptographic hash may occur at the same time or at different times. The transmission of the authentic cryptographic hash 80 to authentication server 28 may occur prior to or immediately after the transmission of the download request to client network device 32.

Upon receiving the download request and cryptographic hash 82, client network device 32 transmits and authentication request 84 two authentication server 28, requesting that authentication server 28 verify that the received cryptographic hash CH1 is authentic. Thereafter, authentication server 28 compares the received cryptographic hash CH1 against the values of the cryptographic hash is stored cryptographic hash storage 54. In the example illustrated, the cryptographic hash CH1 is authentic, resulting in authentication server 28 responding within indication 86 that the cryptographic hash is authentic, wherein client network device 32 responds by downloading the file pursuant to the request or carry out additional supplemental security protocols.

FIG. 1 further illustrates a second file downloading transaction between image download requester 24B and client network device 32. The second illustrated file downloading transaction illustrates the serving of multiple image download requester 24 by authentication server 28. In the example illustrated, image download requester 24B generates an authentic cryptographic hash (CH2) 90 which is transmitted to authentication server 28 for storage in cryptographic hash storage 54. Image download requester 24B further transmits a software image download request (DOWNLOAD 2 REQUEST) and the authentic graphic hash (ACH2) 92 to client network device 32 across a wide area network. In one implementation, the transmission of the download request and the authentic cryptographic hash may occur at the same time or at different times. The transmission of the authentic cryptographic hash 90 to authentication server 28 may occur prior to or immediately after the transmission of the download request to client network device 32.

Upon receiving the download request and cryptographic hash 92, client network device 32 transmits and authentication request 94 to authentication server 28, requesting that authentication server 28 verify that the received cryptographic hash CH1 is authentic. Thereafter, authentication server 28 compares the received cryptographic hash CH1 against the values of the cryptographic hash is stored cryptographic hash storage 54. In the example illustrated, the cryptographic hash CH2 is authentic, resulting in authentication server 28 responding within indication 96 that the cryptographic hash is authentic, wherein client network device 32 responds by downloading the file pursuant to the request or carry out additional supplemental security protocols.

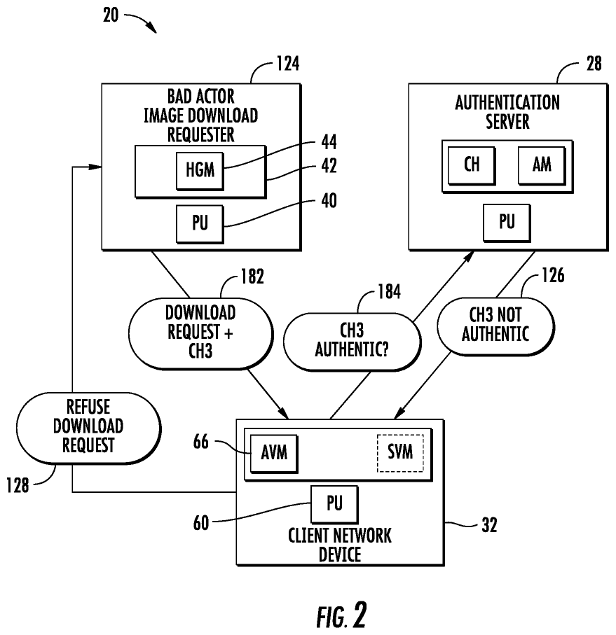

FIG. 2 schematically illustrates other portions of the example network system 20. FIG. 2 illustrates system 20 additionally comprising a bad actor image download requester 124 which may communicate with client network device 30 2B is the same wide area network. As shown by FIG. 2, the bad actor image download requester may be similar to the image download requester's 24. Bad actor image download requester 124 may similarly include a processing unit 40 and a memory 42 which includes a hash generation module 44. However, as the image download requester 124 is a bad actor, requester 124 may not comprise a download request security module 46 and/or may not therefore transmit a generated authentic computer hash (such as hash 80 or 90) to authentication server 28. With system 20, the end result is that client network device 32 denies or refuses downloading of the file pursuant to the request from requester 124, reducing risk of corruption of claim network device 32 resulting from just the download of the file pursuant to the request.

FIG. 2 illustrates an example attempt at a file downloading transaction by bad actor image download requester 124. The transaction may be initiated by requester 12 for transmitting a download request 182 to client network device 32. The download request may or may not include a cryptographic hash, such as CH3.

In response to client network device 30 to receiving the download request from requester 124 (which may deceptively portray itself as a different requester, such as one of requesters 24), authentication verification module 66 directs processing unit 60 to transmit and authentication request 184, along with the received candidate cryptographic hash CH3 to authentication server 28. Thereafter, authentication server 28 compares the received cryptographic hash CH3 against the values of the cryptographic hash is stored cryptographic hash storage 54. In the example illustrated, the cryptographic hash CH3 is not authentic, resulting in authentication server 28 responding within indication 126 that the cryptographic hash is inauthentic or does not match any cryptographic hash value stored in cryptographic hash storage 54, authentication verification module 66 may direct processing unit 60 to not acknowledge the download request, refuse to download the file pursuant to the request 128 or take other actions other than downloading the file pursuant to the request.

FIG. 3 is a flow diagram of an example software image download security method 200 from a perspective of an image download requester. Although method 200 is described above, it should be appreciated that method 200 may be carried out by other image download requesters which are part of other network systems. As indicated by block 204, image download requester 24A generates an authentic cryptographic hash of a software image/executable file. Examples of such a cryptographic hash include, but are not limited to, MD5, SHA1, and SHA256.

As indicated by block 208, image download requester 24A transmits a download request to a client network device 32 requesting the client network device 32 to download the software image. As indicated by block 212, the image download requester 24A transmits the authentic cryptographic hash of the software image to the client network device 32. It should be appreciated that the order of the transmission may be varied.

As indicated by block 216, image download requester 24A transmits the authentic cryptographic hash of the software image to the authentication server 28, wherein the authentication server is to receive the authentication request from the client network device 32 which includes the same authentic graphic hash.

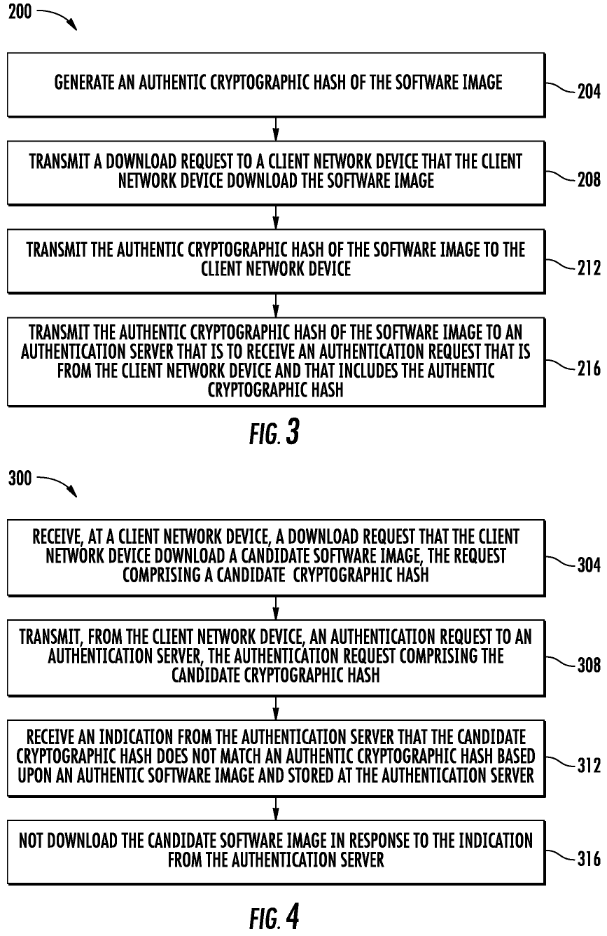

FIG. 4 is a flow diagram of an example software image download security method 300 from a perspective of a client network device, such as client network device 32 above. Although method 300 is described in the context of claim network device 32 of system 20, it should be appreciated that method 300 may be carried out by other client network devices so she with other network systems.

As indicated by block 304, client network device 32 receives a download request, a request that the client network device 32 download a candidate software image. The request may further comprise a candidate cryptographic hash. The cryptographic hash may be sent with the candidate software image or separately from the candidate software image.

As indicated by block 308, the client network device 32 transmits an authentication request to an authentication server, such as authentication server 28. The authentication request may comprise the candidate cryptographic hash received in block 304. In some implementations, the authentication request may further identify the candidate software image for further verification by the authentication server.

As indicated by block 312, after verification by the authentication server, client network device 32 receives an indication from the authentication server, across the wide area network, that the candidate cryptographic hash does not match the authentic cryptographic hash based upon an authentic software image that was received by the authentication server and stored by the authentication server. As indicated by block 316, in response to the indication that the software image download request is inauthentic, that the software image to be downloaded is inauthentic or that the requester is in authentic, based upon the response from the authentication server, client network device 32 does not download the candidate software image. Alternatively, in response to the indication that the software image download request is authentic, that the cryptographic hash does indeed match a graphic hash value stored at the authentication server, client network device may follow up by carrying out additional downloading security protocols or may proceed with downloading the software image/executable file pursuant to the request.

FIG. 5 is a flow diagram of an example software image download security method 400 from a perspective of an authentication server, such as authentication server 28. Although method 400 is described in the context of network system 20 described above, it should be appreciated that method 400 may be carried out by other authentication servers and other network systems.

As indicated by block 404 authentication server 28 stores an authentic cryptographic hash for an authentic software image. In one implementation, the authentication server 28 receives the authentic cryptographic hash and stores the authentic cryptographic hash. In another implementation, the authentication server receives a software image/excusable file for which a download request is to be made and generates the authentic cryptographic hash based upon the file. The storage of the cryptographic hash may be made on a memory of the authentication server or on a remote memory accessible by the authentication server.

As indicated by block 408, the authentication server receives an authentication request from a client network device, such as a client network device 32 across a wide area network. The authentication request may comprise a candidate cryptographic hash for a candidate software image for which a download request has been received by the client network device across a wide area network, from the “cloud”.

As indicated by block 412, the authentication server compares the candidate cryptographic hash received from the client network device to the value for at least one cryptographic hash stored by the authentication server or accessed by the authentication server. As indicated by block 416, the result of the comparison is transmitted to the client network device, wherein the client network device is to not download the candidate software image in response to the candidate cryptographic hash not matching the authentic cryptographic hash stored or axis by the authentication server. Alternatively, the client network device may carry out further download security protocols or may carry out downloading of the candidate software image pursuant to the download request in response to receiving an indication from the authentication server that the candidate cryptographic hash does indeed match a stored authentic cryptographic hash.

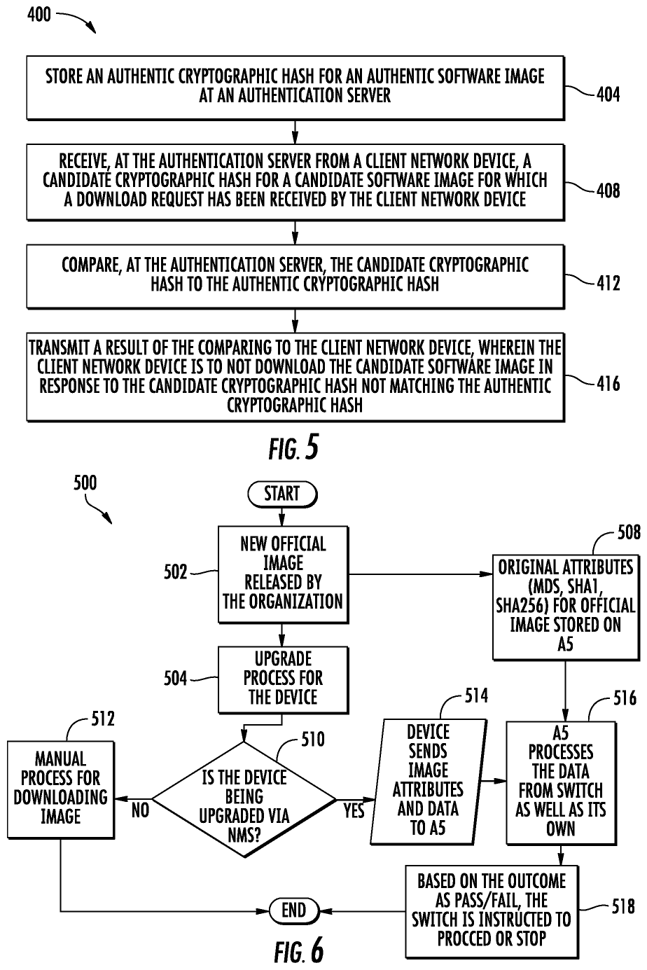

FIG. 6 is a flow diagram of an example software image download security method 500. In the example illustrated, method 500 is at least partially implemented by a network management station (NMS) with respect to a regional switch or router. In other implementations, method 500 may be carried out with other network management stations or in other networks similar to those described above.

As indicated by block 502, a new official software image is created or released by an organization. For example, as indicated by block 504, in one implementation, the software image may be an executable file for upgrading or patching an existing executable file at a client network device. In one implementation, the software image may be an executable file for being carried out by a regional router. For example, the executable file may control switching of transmissions for different destinations of the regional router. [Please verify our supplement]

As indicated by block 508, the A cryptographic hash generated based upon the content of the software image is stored on the authentication server (AS). In one implementation, the cryptographic hash is generated by the organization and is manually stored at the authentication server. In another implementation, the cryptographic hash is generated by the organization and is transmitted and automatically stored at the authentication server. In another implementation, the file to be downloaded pursuant to the request is transmitted to the authentication server, the authentication server generates the cryptographic hash. Examples of the cryptographic hash include, but are not limited to, cryptographic hash values using, MD5, SHA1, and SHA256.

As indicated by decision block 510, handling of the software image download request proceeds dependent upon whether the particular client network device, such client network device 32 (the regional router in the example is operating pursuant to the software image download security method or protocol described in this disclosure. As indicated by block 512, if the particular client network device 32 is not operating pursuant to the software image download security method, handling of the software image download request is carried out manually or in a manner similar to current software image download procedures. As discussed above, in some instances, this may render the client network device 32 vulnerable to viruses, Trojan horses and the like.

Alternatively, as indicated by block 514, if the client network device 32 is operating pursuant to the software image download security method wherein client network device 32 comprises authentication verification module 66 left and described above), the client network device 32 transmits an authentication request to the authentication server a front such as medication server 28 described above). In one implementation, device 32 sends both attributes of the software image and its data, including the cryptographic hash received from the organization, to the authentication server.

As indicated by block 516, upon receiving the authentication request from the never client network device, the authentication server processes the data from the network client network device (in this example, the regional router or switch) and its own data (the data comprising the stored cryptographic hash values received from the organization are generated based upon data received from the organization). In one implementation, the authentication server compares the candidate cryptographic hash season block 514 to the stored cryptographic hash values in cryptographic hash stored 54 (shown in FIG. 1). The authentication server then transmits the results of the comparison, a match or a failed match to the client network device that made the authentication request. As indicated by block 518, based upon the outcome of the comparison, a pass or fail regard to the candidate cryptographic hash, the client network device (router a regional switch in the example) proceeds. In the case of a pass/cryptographic hash match, the client network device (regional router or switch) proceeds with additional download security checks or proceeds with downloading the software image pursuant to the request. In the case of a fail/cryptographic hash mismatch or no match, the client network device proceeds by declining or refusing to download the software image pursuant to the download request.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A software image download security method comprising:
storing an authentic cryptographic hash for an authentic software image at an authentication server;
receiving, at the authentication server from a client network device, a candidate cryptographic hash for a candidate software image for which a download request has been received by the client network device;
comparing, at the authentication server, the candidate cryptographic hash to the authentic cryptographic hash; and
transmitting a result of the comparing to the client network device, wherein the client network device is to not download the candidate software image in response to the candidate cryptographic hash not matching the authentic cryptographic hash.

2. The software image download security method of claim 1, wherein the authentication server receives the authentic cryptographic hash from a network device source of the software image.

3. The software image download security method of claim 1, wherein the cryptographic hash is selected from a group of cryptographic hashes consisting of MD5, SHA1 and SHA256.

4. The software image download security method of claim 1, wherein the client network device comprises a network switch.

5. The software image download security method of claim 1 further comprising:
storing a second authentic cryptographic hash for a second authentic software image at the authentication server;
receiving, at the authentication server from a second client network device, a second candidate cryptographic hash for a candidate software image for which a download request has been received by the second client network device;
comparing, at the authentication server, the second candidate cryptographic hash to the second authentic cryptographic hash; and
transmitting a result of the comparing to the second client network device, wherein the second client network device is to not download the second candidate software image in response to the second candidate cryptographic hash not matching the second authentic cryptographic hash.

6. The software image security download security method of claim 1, further comprising receiving, at the authentication server, the authentic cryptographic hash for the authentic software image from a source network device.

7. A software image download security method comprising:
receiving, at a client network device, a download request that the client network device download a candidate software image, the request comprising a candidate cryptographic hash;
transmitting, from the client network device, an authentication request to an authentication server, the authentication request comprising the candidate cryptographic hash;
receiving an indication from the authentication server that the candidate cryptographic hash does not match in authentic cryptographic hash-based upon an authentic optical image and stored at the authentication server; and
not downloading the candidate software image in response to the indication from the authentication server.

8. The software image download security method of claim 7 comprising:
receiving, at the client network device, a second download request that the client network device download a second candidate software image, the request comprising a second candidate cryptographic hash;
transmitting, from the client network device, a second authentication request to the authentication server, the second authentication request comprising the second candidate cryptographic hash;
receiving a second indication from the authentication server that the candidate cryptographic hash matches a second authentic cryptographic hash that is based upon a second authentic optical image and that is stored at the authentication server; and
downloading the second candidate software image in response to the second indication from the authentication server.

9. The software image download security method of claim 7, wherein the authentication server receives the authentic cryptographic hash from a network device source of the software image.

10. The software image download security method of claim 7, wherein the cryptographic hash is selected from a group of cryptographic hashes consisting of MD5, SHA1 and SHA256.

11. The software image download security method of claim 7, wherein the client network device comprises a network switch.

12. A non-transitory computer-readable medium containing software image download security instructions to direct a processing unit to:
transmit a download request to a client network device that the client network device download a software image;
generate an authentic cryptographic hash of the software image;
transmit the authentic cryptographic hash of the software image to the client network device; and
transmit the authentic cryptographic hash of the software image to an authentication server that is to receive an authentication request that is from the client network device and that includes the authentic cryptographic hash.

13. The non-transitory computer-readable medium of claim 12, wherein the instructions are to further direct the processing unit to:
transmit a download request to a second client network device that the second client network device download the software image; and
transmit the authentic cryptographic hash of the software image to

14. The non-transitory computer-readable medium of claim 12, wherein the cryptographic hash is selected from a group of cryptographic hashes consisting of MD5, SHA1 and SHA256.

15. The non-transitory computer-readable medium of claim 12, wherein the client network device comprises a network switch.
